(19) United States
(12) Patent Application Publication
(10) Pub. No.: US 2015/0081269 A1
(43) Pub. Date: Mar. 19, 2015

(54) Language Localization Of Java Applications

(71) Applicant: Rajeevlochan Phadke, Pune (IN)

(72) Inventor: Rajeevlochan Phadke, Pune (IN)

(73) Assignee: LINGUA NEXT TECHNOLOGIES PVT. LTD., Pune (IN)

(21) Appl. No.: 14/481,017

(22) Filed: Sep. 9, 2014

Related U.S. Application Data
(60) Provisional application No. 61/878,748, filed on Sep. 17, 2013.

(51) Int. Cl. G06F 17/28; G06F 9/45; G06F 9/455

(52) U.S. Cl. CPC G06F 17/289; G06F 9/45533; G06F 8/40
USPC 704/2

(57) ABSTRACT

A method and system for executing a Java application on a computing device. According to a first aspect of the invention, a Java virtual machine, that executes the Java application on the computing device, is modified. The Java virtual machine is modified to translate text strings, associated with the application, from a first language to a second language. The text strings are translated from the first language to the second language using a translator module. According to a second aspect of the invention, one or more additional classes are included in the Java application. The one or more additional classes transmit the text strings to a translator module to translate the text strings from the first language to the second language.

### CROSS REFERENCE

This application claims priority from the U.S. provisional application No. 61/878,748, titled “LANGUAGE LOCALIZATION OF JAVA APPLICATIONS”, filed on Sep. 13, 2013, the disclosure of which is hereby incorporated by reference.

### TECHNICAL FIELD

The presently disclosed embodiments are related, in general, to Java applications used to program computing devices. More particularly, the presently disclosed embodiments are related to methods and systems for language localization of Java applications.

### BACKGROUND

Software applications are released globally and thus need to support various languages as per the region in which the software applications need to be released. Conventionally, internationalization and localization techniques are used to make the software applications compliant with various languages. In an embodiment, internationalization and localization refer to customizing a software application for a predetermined region. For example, a software application that has been internationalized and localized for a Japan region may have a Japanese user interface and may support Japanese text, the Japanese calendar, and currency. A software developer may have to hard code the text strings in the software application, or may have to modify the code to use externalized strings to provide support for each region. Therefore, in some cases, a single software application may have different versions for different regions. Further, any update of the software application (planned to be released later) may have to be customized separately for each region (because the software application may have been modified for each region separately).

Developing such software applications may be an expensive and effort taking task, for the developers, as developers have to hard code the support for different regions separately or change the code to read the strings from an external source.

Thus, there remains a need for achieving the effective way of language localization for the software applications.

### SUMMARY

Various embodiments of the present invention have been disclosed for carrying out language localization of Java applications.

According to a first embodiment illustrated herein, there is provided a method and system for translating text strings associated with a Java application by modifying a Java virtual machine configured to execute the Java application. The text strings correspond to text data, associated with the Java application, which is to be displayed on a display of a computing device. The Java virtual machine is modified by adding an interception class and a communication class to one or more classes of the Java virtual machine. Further, pointcuts are included (in the interception class) for the text-displaying class (called by the Java application to display the text strings) of the Java virtual machine. The pointcuts redirect execution of the text-displaying class to the communication class. The communication class facilitates communication between the interception class and a translator means. The translator means is configured to translate the text strings from a first language to a second language.

During the execution of the Java application, the Java application calls the text-displaying class to display the text strings. In response to the call, the pointcuts redirect the text strings to the communication class. The communication class transmits the text strings in the first language to the translator means, and receives the text strings in the second language from the translator means. The text strings in the second language are transmitted back to the text displaying class. The text-displaying class displays the text strings in the second language on the display of the computing device. Further, images, associated with the Java application, which include text strings in the first language, can be substituted with images, which include the text strings in the second language.

Language localization of Java applications in accordance with the first embodiment (in which the java virtual machine is modified) require no changes in the Java application. Translation of the text strings for any Java application being executed on the computing device can be carried out in accordance with the method illustrated in the first embodiment. Further, in accordance with the first embodiment, language localization can be achieved for updated versions of the Java application, as no changes are required in the Java application.

According to a second embodiment illustrated herein, there is provided a method for translating text strings associated with a Java application by inserting an additional class to one or more classes of the Java application. The method comprises uncompressing the one or more classes of the Java application. The method further comprises adding an interception class and a communication class, to the one or more classes of the Java application. Further, pointcuts are included (in the interception class) for text-handling class (called by the Java application when the text strings are to be displayed) of the Java application. The pointcuts redirect execution of the text-handling class to the communication class by transmitting the text strings to the communication class. Thereafter, the communication class further transmits the text strings to the translator means. The translator means is configured to translate the text strings from a first language to a second language. Substitute images, which correspond to original images included in Java application may be added to the Java application. The original images include text data in the first language and the substitute images include text data in the second language. The Java application may be rebuilt to include the substitute images.

During the execution of the Java application, when the text strings are to be displayed, the text-handling class of the Java application is called. The pointcuts for the text-handling class (included in the interception class) intercepts the call. In response to the interception of the call, the pointcuts redirect the text strings to the communication class. The communication class transmits the text strings in the first language to the translator means, and receives the text strings in the second language from the translator means. The text strings in the second language are then transmitted to the text-handling class. The Java virtual machine displays the text strings in the second language on the display of the computing device. Further, the original images, associated with the Java application, which include text strings in the first language, can be substituted with the substitute images, which include the text strings in the second language.

Language localization of Java applications in accordance with the second embodiment require no changes in the Java virtual machine. Thus, no permission or support is required from the computing device OEM. Further, in accordance with the second embodiment, language localization can be achieved for targeted Java applications. Language localization of Java applications in accordance with the second embodiment requires inserting an additional class to one or more classes of a target Java application without changing the source code of the target Java application.

In an embodiment, the method in accordance to the first embodiment (modifying the java virtual machine) and the method in accordance to the second embodiment (modifying the Java application) are two independent methods.

### BRIEF DESCRIPTION OF DRAWINGS

The following detailed description of the embodiments of the present invention will be better understood when read in conjunction with the appended drawings. The present invention is illustrated by way of example, and not limited by the accompanying figures, in which like references indicate similar elements.

FIG. 1 is a block diagram illustrating a computing device, in accordance with an embodiment of the invention;

FIG. 2 is a block diagram illustrating a computing device, in accordance with a first embodiment of the invention;

FIG. 3 is a flowchart illustrating a method for language localization of a Java application, in accordance with the first embodiment of the invention;

FIG. 4 is a flowchart illustrating a method for executing a Java application, in accordance with the first embodiment of the invention;

FIG. 5 is a block diagram illustrating a computing device, in accordance with a second embodiment of the invention;

FIG. 6 is a flowchart illustrating a method for language localization of a Java application, in accordance with the second embodiment of the invention; and

FIG. 7 is a flowchart illustrating another method for executing an application, in accordance with the second embodiment of the invention.

### DETAILED DESCRIPTION

The invention can be best understood with reference to the detailed figures and description set forth herein. Various embodiments are discussed below with reference to the figures. However, those skilled in the art will readily appreciate that the detailed description given herein with respect to these figures is simply for explanatory purposes. The disclosed systems or circuits extend beyond the described embodiments. For example, those skilled in the art will appreciate that in light of the teachings presented, multiple alternate and suitable approaches may be realized, to implement the functionality of any detail described herein, beyond the particular implementation choices in the following embodiments described and shown.

### GLOSSARY OF TERMS

Definitions: The following terms shall have, for the purposes of this application, the respective meanings set forth below.

A “software application” is representative of one or more computer program instructions that are executable by a processor to carry out operations for a specific application. In an embodiment, the software application may programmed in various languages such as, but not limited to, JAVA, C++, C#, PERL, Python, and VBA. The computer program instructions are compiled and are converted in object codes. Such object codes are then executed by the processor to perform predetermined operations on a computing device.

An “operating system” refers to software that manages hardware and software resources, of a computing device. Further, the operating system may perform basic operations such as process execution, memory management, file management, and the like. Further, the operating system provides an interface to a user of the computing device, to interact with hardware and software applications on the computing device.

A “runtime environment” refers to an interface between a software application and an operating system installed on a computing device. The runtime environment enables execution of the software application on the operating system. Further, the runtime environment enables a software developer to develop an operating system independent software application. In an embodiment, the runtime environment includes programming language specific APIs (application programming interfaces) and operating system specific APIs. Further, the runtime environment maps the programming language specific APIs with operating system specific APIs. For example, a display function in the runtime environment may be mapped to corresponding display API of the operating system.

A “class” refers to a template or set of instructions to build a specific type of object. A class is designed and programmed to accomplish a single task. Plurality of classes is used to build a software application.

“Text strings” refer to text, associated with the software application, which are to be displayed on a display of a computing device. In an embodiment, the text strings refer to text that is presented on a user interface associated with the software application.

“Language localization” of a software application refers to a process for enabling translation of the text strings, associated with the software application, from a first language to a second language.

A “pointcut” refer to a set of join points in the control flow of a computer program in aspect-oriented computer programming. When execution of the computer program reaches one or more joint points described in the pointcut, an additional program code associated with the pointcut is executed. The pointcut allows a programmer to describe when and where the additional program code needs to be executed in addition to the already existing computer program.

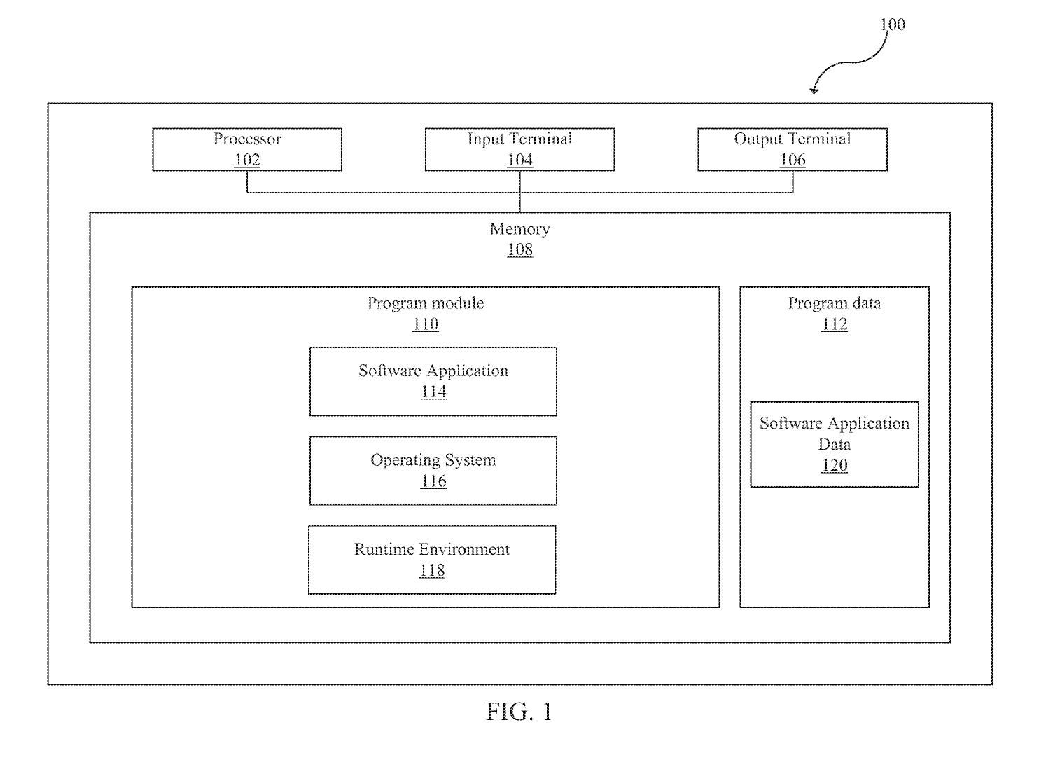

FIG. 1 is a block diagram illustrating a computing device 100, in accordance with at least one embodiment of the invention. The computing device 100 includes a processor 102 (such as a microprocessor), an input terminal 104, an output terminal 106, a memory 108, and/or any other electronic component, to perform one or more operations according to one or more programming instructions. Memory 108 includes a program module 110 and a program data 112. Program module 110 includes a software application 114, an operating system 116, and a runtime environment 118. Program data 112 includes a software application data 120.

Examples of computing device 100 include, but are not limited to, a desktop computer, a laptop, a personal digital assistant (PDA), a tablet/handheld computer, and the like.

Although FIG. 1 shows only one software application i.e. software application 114 for simplicity, it will be apparent to a person having ordinary skill in the art that the disclosed embodiments can be implemented for a plurality of software applications.

Processor 102 executes a set of instructions stored in memory 108 to perform the one or more operations on computing device 100. Processor 102 may be realized through a number of processor technologies known in the art. Examples of processor 102 may include, but are not limited to, an X86 processor, a RISC processor, an ASIC processor, a CISC processor, or any other processor. In an embodiment, processor 102 may include a graphics-processing unit (GPU) that executes the set of instructions to perform one or more image processing operations.

Input terminal 104 refers to a hardware device that is configured to receive input from a user. Examples of input terminal 104 may include, but are not limited to, a keyboard, a mouse, a joystick, a touch screen, a microphone, a camera, a motion sensor, a light sensor, and/or a docking station.

In an embodiment, output terminal 106 refers to a hardware device that is used for presenting information to a user of computing device 100. In an embodiment, output terminal 106 may correspond to a display device, coupled to computing device 100, which displays a user interface associated with software application 114. Examples of output terminal 106 may include, but are not limited to, the display of computing device 100, and/or a multifunction device (such as a printer/scanner), a speaker.

Memory 108 is configured to store a set of instructions and data. Some of the commonly known memory implementations can be, but are not limited to, a random access memory (RAM), a read only memory (ROM), a hard disk drive (HDD), and a secure digital (SD) card. Program module 110 includes a set of instructions executable by processor 102 to perform a set of predefined operations on computing device 100. In an embodiment, the set of instructions, when executed by processor 102, may perform specific actions to translate language of text strings associated with software application 114 from a first language to a second language. It is understood by a person having ordinary skill in the art that the set of instructions in conjunction with various hardware of computing device 100 enables computing device 100 to perform various operations. During the execution of instructions, data from software application data 120 may be accessed by processor 102.

Software application 114 is a set of one or more computer program codes executable by processor 102 to carry out operations for a specific application. The computer program code can be written in various programming languages including, but not limited to, ‘C++’, ‘Objective-C’, ‘Smalltalk’, ‘Delphi’, ‘Java’, ‘JavaScript’, ‘C#’, ‘Perl’, ‘Python’, ‘Ruby’ and ‘PHP’.

Operating system 116 is a software that manages hardware and software resources, of computing device 100, including basic tasks such as process execution, memory management, file management, and the like. Operating system 116 provides functionality through which a user can access software application 114 and other computer programs stored in memory 108 of computing device 100. Operating system 116 acts as an interface for software application 114 (and the other computer programs) to interact with physical hardware components of computing device 100, such as a display, speakers, earphones, a microphone, a gyroscope, an accelerometer, a global positioning system (GPS), a wireless network interface, a video camera, a flash bulb, a clock, and/or memory 108. Various examples of operating system 116 may include, but are not limited to, Windows, Linux, Android, BlackBerry OS, Symbian, and iOS.

Runtime environment 118 refers to an interface between software application 114 and operating system 116. Runtime environment 118 enables the interaction of software application 114 with operating system 116. The software application 114 may be programmed according to the API of runtime environment 118. Runtime environment 118 may in turn convert the call made to the API of runtime environment 118, to the corresponding operating system's API. Thus, runtime environment 118 enables software application 114 to be independent of operating system 116. Various example of runtime environment 118 can be a Java™ runtime environment (JRE), Java virtual machine, a Microsoft®.NET runtime environment, Dalvik, Android Runtime, and the like. In an embodiment, runtime environment 118 may be dependent on operating system 116. For example, the Windows™ operating system uses a version of SUN™ Java Runtime Environment (JRE) as runtime environment 118. Similarly, the Android operating system uses Dalvik or Android Runtime (ART) as runtime environment 118.

The software application data 120 stores data associated with the software application 114. In an embodiment, any data (such as input/output data) generated during the execution of the software application 114 may be temporarily stored in the software application data 120.

For the purpose of description of various embodiments of the present disclosure, the software application 114 is considered to be a Java application and the runtime environment 118 is considered to be a Java Virtual machine (JVM). However, it should be apparent to those skilled in the art that the various embodiments described herein can be implemented for any other software application 114 that is written in programming languages other than JAVA, and their corresponding runtime environment 118.

In a Java environment, a java virtual machine (JVM) (alternatively called a java runtime environment (JRE)) is deployed on the computing device 100 for achieving cross-platform capabilities of the java applications. Various operating systems installed on the computing device 100 have different versions of JVMs/JREs to leverage the operating system compatibility of the various java applications.

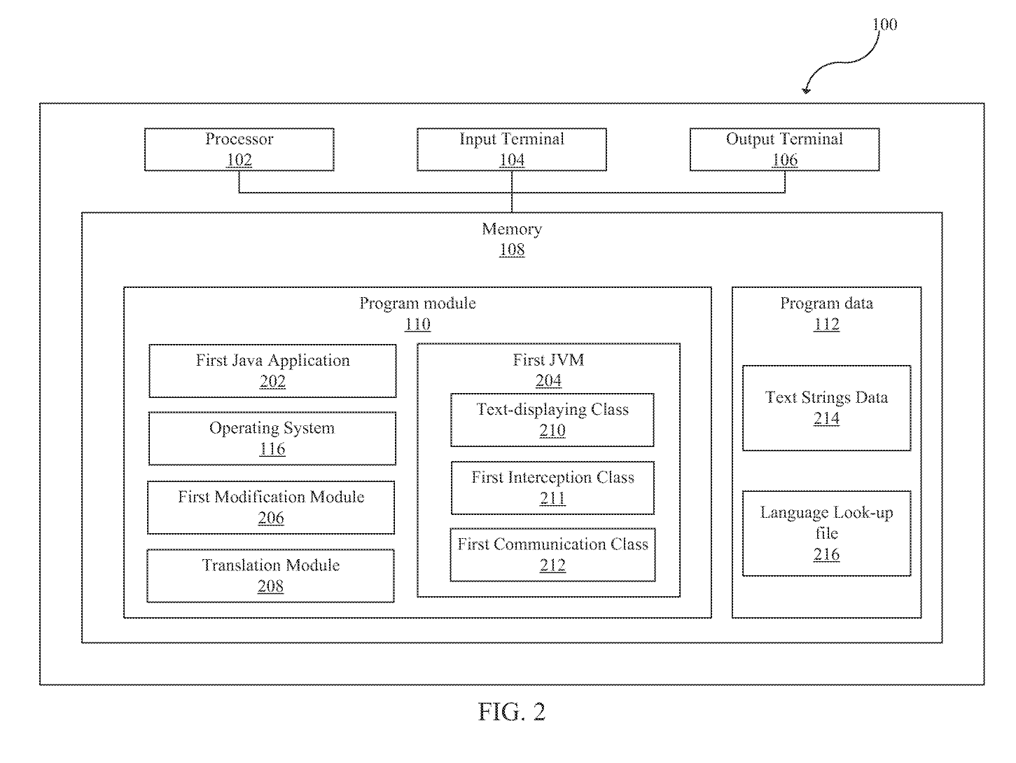

FIG. 2 is block diagram illustrating computing device 100, in accordance with the first embodiment of the invention. As shown in FIG. 2, program module 110 includes operating system 116, a first Java application 202, a first Java Virtual Machine (JVM) 204, a first modification module 206, and a translation module 208. First JVM 204 includes a plurality of JVM classes. The plurality of JVM classes is program instructions stored in the memory 108 that enables execution of first Java application 202. In an embodiment, first JVM 204 may include at least one text-displaying class 210, a first interception class 211, and a first communication class 212. Program data 112 includes a text strings data 214 and a language look-up file 216.

First Java application 202 can correspond to any software application for which the program code is written in Java programming language. In an embodiment, first Java application 202 is a collection of classes included in a “jar” file associated with first Java application 202. Further, the “jar” file includes a configuration file that defines dependencies among the one or more classes. In an embodiment, first Java application 202 may include one or more classes to display content, associated with first Java application 202, on the display of computing device 100. In an embodiment, the content may correspond to one or more text strings in a first language that are to be displayed on the display of computing device 100.

First JVM 204 is a Java virtual machine that acts as an interface between first Java application 202 and operating system 116. In an embodiment, first Java application 202 is executed by processor 102 on operating system 116 through first JVM 204. First JVM 204 interprets a compiled Java binary code for processor 102 to perform instructions associated with first Java application 202. In an embodiment, first JVM 204 includes the plurality of JVM classes included in “jar” files associated with the first JVM 204. In an embodiment, out of the plurality of JVM classes, at least one class corresponds to text-displaying class 210. In an embodiment, text-displaying class 210 enables first Java application 202 to display content on the display of computing device 100.

Text-displaying class 210 displays the text strings associated with first Java application 202 on output terminal 106 (hereinafter referred to as the display of computing device 100). First Java application 202 calls text-displaying class 210 to display the text strings on the display of the computing device 100.

First interception class 211 comprises pointcuts for text-displaying class 210 of first JVM 204. First interception class 211 intercepts a call made by first Java application 202, for displaying the text strings, to text-displaying class 210 of first JVM 204 through pointcuts. First interception class 211 intercepts the text strings included in the call made by first Java application 202 before the text strings are transmitted to text-displaying class 210. Further, first interception class 211 transmits the intercepted text strings to first communication class 212. First interception class 211 provides the text strings, which are translated from the first language to the second language, to text-displaying class 210.

First communication class 212 enables communication between first interception class 211 and translation module 208. First communication class 212 receives the intercepted text strings in the first language from first interception class 211. Further, first communication class 212 transmits the text strings in the first language to translation module 208 and receives the text strings in the second language from translation module 208. First communication class 212 then provides the text strings received in the second language to first interception class 211. In turn, first interception class 211 provides the received text strings in the second language to text-displaying class 210.

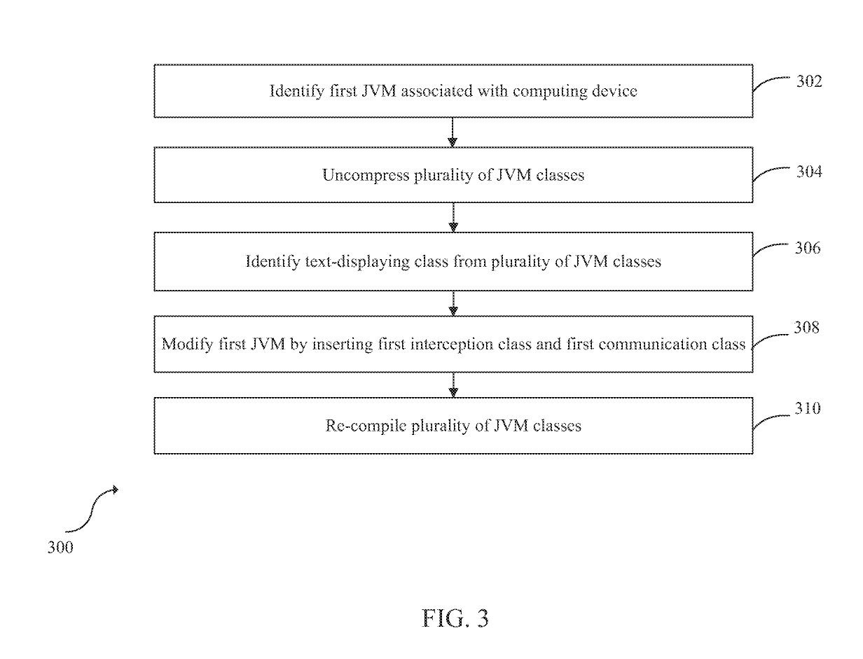

First modification module 206 is configured to modify first JVM 204 by inserting one or more classes in addition to the existing plurality of JVM classes. In an embodiment, first modification module 206 modifies first JVM 204, by inserting first interception class 211 and first communication class 212. Further, first modification module 206 is configured to insert pointcuts for text-displaying class 210. The pointcuts are included in first interception class 211. First interception class 211 intercepts (through pointcuts) the text strings to be displayed on the display of computing device 100, and redirects the text strings to first communication class 212 for translation purposes. The modification of text-displaying class 210 has been described later in conjunction with FIG. 3.

Translation module 208 translates the text strings in a first language to a second language. In an embodiment, the first language of the text strings corresponds to a default language of the text strings included in first Java application 202 during the application development. Further, the second language corresponds to a target language in which the text strings are to be translated. In an embodiment, translation module 208 can refer to language look-up file 216 to translate the text strings from the first language to the second language. In another embodiment, translation module 208 may be a machine translator that translates the text strings from the first language to the second language. In an embodiment, the translation module 208 may be a phonetic engine configured to convert the text stings into phonetic representation of the first language or the second language. Further, in an embodiment, translation module 208 may transmit the text strings to online translation services such as, but are not limited to, Google Translate, Bing, and Babylon.

The text strings data 214 includes the text strings that are transmitted to and/or received from the translation module 208. In an embodiment, the text strings in the first language and the second language may be cached in the text strings data 214.

Language look-up file 216 is a look-up table representative of a one-to-one correspondence between the text strings in the first language and the second language. In an embodiment, language look-up file 216 may be created by a user and/or a vendor. In an embodiment, processor 102 may automatically create language look-up file 216 based on text strings data 214. In such an embodiment, the text strings, translated using the one or more online translation services, are cached, in the first language and the second language, in the text strings data 214. Using the cached text strings, the processor 102 may generate/update language look-up file 216.

FIG. 3 is a flowchart 300 illustrating a method for language localization of a Java application, in accordance with the first embodiment of the invention. The flowchart 300 has been described in conjunction with FIG. 1 and FIG. 2.

The method for modifying the Java virtual machine is explained with reference to various modules and classes included in program module 110. However, those skilled in the art will readily appreciate that the various modules and classes included in program module 110 are a set of computer program codes that are executed by processor 102 to perform tasks associated with the respective modules and classes.

At step 302, a JVM associated with computing device 100 is identified by first modification module 206. In an embodiment, based on operating system 116 installed on computing device 100, the JVM associated with computing device 100 is identified. First modification module 206 determines operating system 116 installed in computing device 100. In an embodiment, first modification module 206 may employ one or more known techniques to identify operating system 116. Thereafter, based on the identified operating system 116, first modification module 206 may identify the JVM on computing device 100. For example, the Windows™ operating system uses a version of the SUN™ JRE as JVM. Similarly, the android operating system uses the JVM known as Dalvik or Android Runtime (ART) as JVM.

At step 304, the identified JVM (i.e. first JVM 204) is uncompressed to extract (or unzip) the plurality of JVM classes included in a compressed (or zipped) folder of the identified JVM. A person having ordinary skill in the art would understand that JVM includes a plurality of jar file that further includes one or more JVM classes. Such JVM classes are compiled and compressed to form the jar files. In an embodiment, first modification module 206 is configured to uncompress the plurality of JVM classes of first JVM 204. In an embodiment, the plurality of JVM classes is the stored program instructions, stored in memory 108, to perform one or more tasks. Examples of the plurality of JVM classes may include, but are not limited to, system classes, standard extension classes, middleware classes, application classes, and so forth. In an embodiment, the plurality of JVM classes may be extracted by decompressing “jar” files corresponding to the identified JVM.

At step 306, text-displaying class 210 of first JVM 204 is identified from the plurality of JVM classes. In an embodiment, first modification module 206 is configured to identify text-displaying class 210. Text-displaying class 210 facilitates the display of the text strings, associated with first Java application 202, on the display of computing device 100. For example, text-displaying class 210 may be used to display the text strings in menus, captions, buttons, and other display areas on the display (such as a display screen) of the computing device 100 with suitable font-size, color, location co-ordinates etc. as defined in first Java application 202.

At step 308, first JVM 204 is modified. In an embodiment, first modification module 206 is configured to modify first JVM 204. In an embodiment, first JVM 204 is modified by adding first interception class 211 and first communication class 212 in the plurality of JVM classes of first JVM 204. In an embodiment, first modification module 206 may introduce first interception class 211 and first communication class 212 as independent classes in the first JVM 204. In such a scenario, first modification module 206 may introduce pointcuts for text-displaying class 210. The pointcuts are introduced in first interception class 211. The pointcuts, included in first interception class 211, redirect the text strings to first communication class 212 when first Java application 202 calls text-displaying class 210 to display the text strings on the display of computing device 100.

At step 310, the plurality of JVM classes are re-compiled. In an embodiment, first modification module 206 is configured to re-compile the plurality of JVM classes to generate a modified JVM. In an embodiment, modified JVM includes first interception class 211 and first communication class 212.

In an embodiment, first modification module 206 may replace the identified JVM (that does not include first communication class 212) with the modified JVM (that includes first communication class 212) as first JVM 204. Further, in an embodiment, when language localization is no longer required, a flag associated with the modified JVM may be set. In such an embodiment, when the flag is set, first interception class 211 is inhibited from intercepting any call made by first Java application 202, to text-displaying class 210 of first JVM 204.

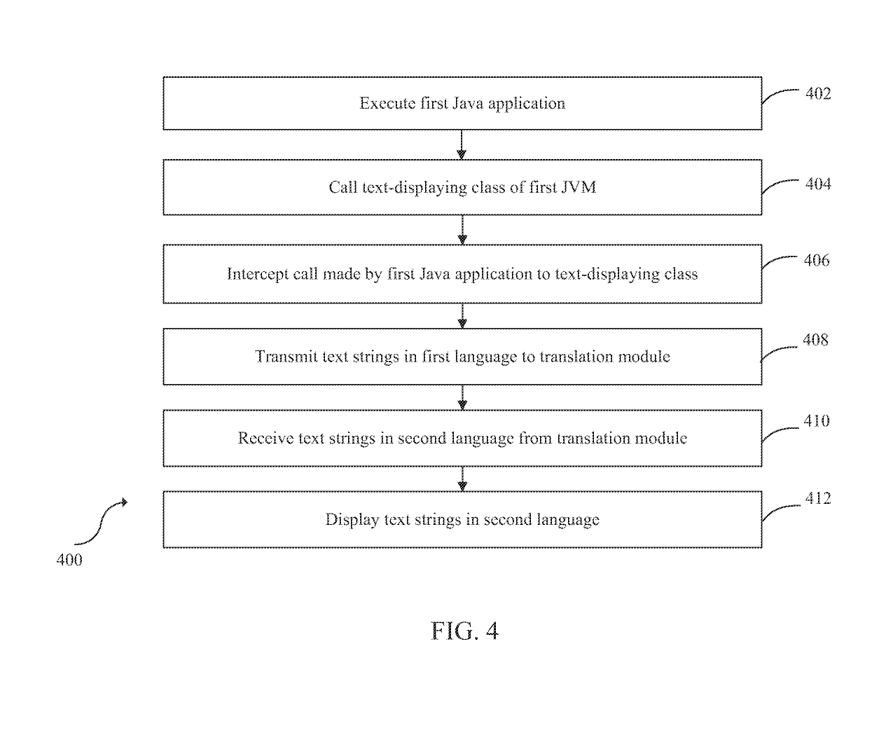

FIG. 4 is a flowchart 400 illustrating a method for executing a Java application, in accordance with the first embodiment of the invention. The flowchart 400 is explained in conjunction with elements of FIG. 1 and FIG. 2.

At step 402, first Java application 202 is executed. In an embodiment, first java application 202 is executed by processor 102 by utilizing the plurality of JVM classes of first JVM 204. In an embodiment, first Java application 202 may be executed in response to a user input received via input terminal 104.

In an embodiment, the user may further provide input corresponding to the second language in which the user wishes to see the text strings, associated with first java application 202, on the display of computing device 100. In an embodiment, computing device 100 may include a location identification module (not shown) that may be configured to determine the location of computing device 100. Based on the location, processor 102 may determine the second language. For example, if the location identification module determines that the location of computing device 100 is India, processor 102 may determine the second language as Hindi. Similarly, if the location identification module determines that the location of computing device 100 is France, processor 102 may determine French as the second language.

At step 404, text-displaying class 210 of first JVM 204 is called by first Java application 202. In an embodiment, while execution of first java application 202, processor 102 may come across a portion of a computing code that corresponds to displaying the text strings on the display of computing device 100. In an embodiment, the portion of the computer code may call text-displaying class 210 (in first JVM 204) to display the text strings. The text strings to be displayed are included in the call made by first Java application 202.

At step 406, the call made by first Java application 202 to text-displaying class 210 is intercepted. In an embodiment, the call is intercepted through the pointcuts introduced, for text-displaying class 210, in first interception class 211. In response to the intercepted call, the pointcuts redirect the text strings in the first language, included in the call, to first communication class 212. Thus, the text strings are intercepted by first interception class 211, before the text strings are transmitted to text-displaying class 210.

At step 408, first communication class 212 transmits the text strings in the first language to translation module 208. Translation module 208 translates the received text strings from the first language to the second language. In an embodiment, translation module 208 may utilize language look-up file 216 for translating text strings. Following table illustrates a sample language look-up file 216:

TABLE 1
An illustration of Language look-up file 216

| Text strings in first language | Text strings in second language |
|---|---|
| What is your name? | quel est votre nom |
| How are you? | Comment allez-vous |
| Input your city name | Saisissez votre nom de ville |

Referring to table 1, language look-up file 216 stores one to one correspondence of the text strings in first and second language. For instance, a text string received by translation module 208 is “Input your city name”. Translation module 208 may refer to language look-up file 216 to translate text string to French (i.e., second language). In an embodiment, the processor 102 may maintain language look-up file 216 as an index file.

In an alternate embodiment, translation module 208 may further transmit the text string to an external translation service such as Google translator or Bing translator. Translation module 208 may receive text strings in second language from the external translation service.

After reception of text strings in the second language, translation module 208 transmits the text string in the second language to first communication class 212.

In an embodiment, translation module 208 may monitor the communication of the computing device 100 with external translation service. In an embodiment, the monitoring of the communication may include caching the text strings sent, in first language to the external translation service, and corresponding translated text strings received by computing device 100 in the second language, in language look-up file 216.

At step 410, the text strings in the second language are received by first communication class 212 from translation module 208. The text strings in the second language are provided to first interception class 211 by first communication class 212. First interception class 211 then provides the text strings, which are translated to the second language, to text-displaying class 210 of first JVM 204.

At step 412, the text strings in the second language are displayed on the display of computing device 100 by text-displaying class 210.

A person having ordinary skill in the art would understand that the scope of the disclosure is not limited to translating the language of the text strings to be displayed on computing device 100. In an embodiment, text data in the image can also be translated from the first language to the second language. In such a scenario, according to first embodiment, first JVM 204 may include an image-displaying class. Further, first Java application may include an original image that includes a text data in a first language.

First interception class 211 may intercept a call, made by first Java application 202 to an image-displaying class of first JVM 204, to display the original image having text data in the first language. In an embodiment, a filename of the original image and a path from where the original image is to be retrieved is included in the call made by first Java application 202. In an embodiment, pointcuts may be included in first interception class 211 for the image-displaying class of first JVM 204 to intercept the call. First interception class 211 redirects the file name and path of the original image, included in the intercepted call, to first communication class 212. First communication class 212 transmits the file name and the path of the original image (having text in the first language) to translation module 208.

Translation module 208 determines the file name and path of a substitute image, having text data in the second language, which corresponds to the original image. In an embodiment, translation module 208 may refer to a look-up file (such as language look-up file 216) representative of a one-to-one correspondence between the file name and path of the original image and the corresponding substitute image. In an embodiment, the path of the substitute image may include a hyperlink to retrieve the substitute image from a server. The server may include a repository of substitute images, which corresponds to original images of various Java applications.

Translation module 208 transmits the file name and path of the substitute image (having text data in the second language) to first communication class 212. First communication class 212 transmits the file name and the path of the substitute image to first interception class 211, which in turn provides the file name and the path of the substitute image to the image-displaying class of first JVM 204. The image-displaying class of first JVM 204 retrieves the substitute image using the file name and the path of the substitute image. First JVM 204 displays the substitute image, having text data in the second language, on the display of computing device 100.

Language localization of Java applications in accordance with the first embodiment (in which the java virtual machine is modified) require no changes in the Java application. Translation of the text strings for any Java application being executed on the computing device can be carried out in accordance with the method illustrated in the first embodiment. Further, in accordance with the first embodiment, language localization can be achieved for updated versions of the Java application, as no changes are required in the Java application. Further, as pointcuts are inserted for one or more classes of JVM, the execution of the one or more classes can be redirected to additional class. Thus, language localization can be achieved for Java applications without modifying the original source code of the JVM.

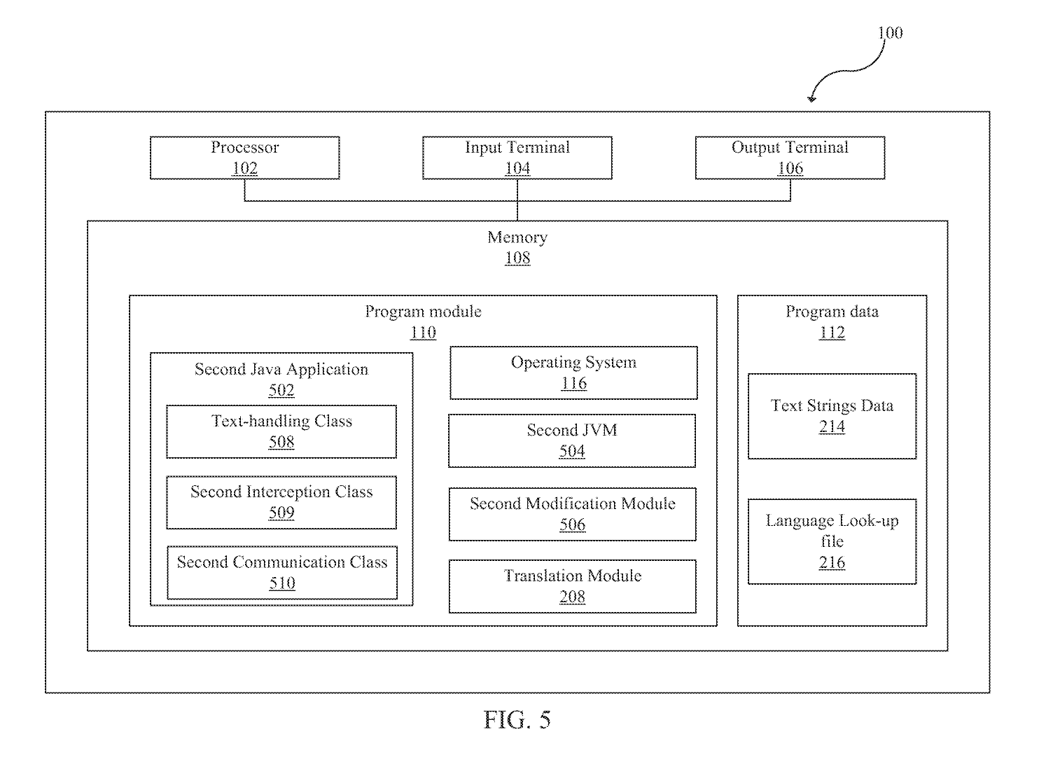

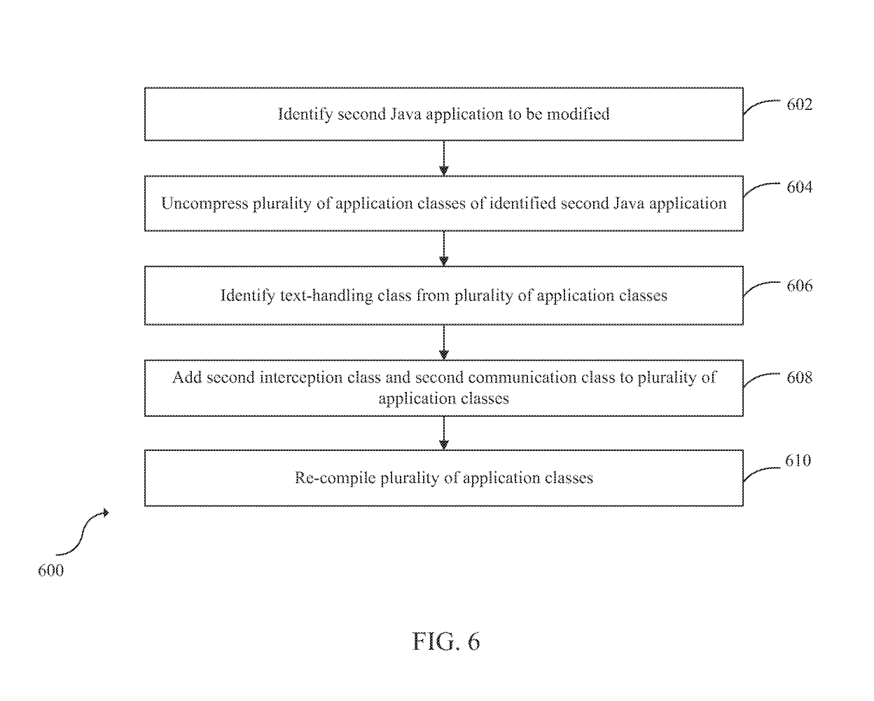

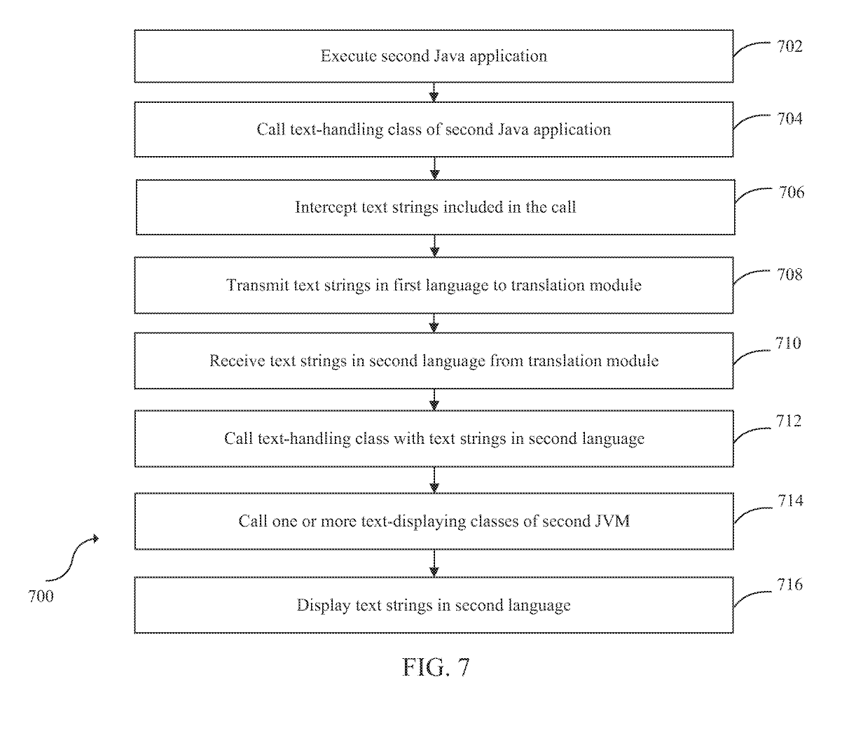

In an embodiment, the scope of the disclosure is not limited to performing language localization by modifying the JVM. In the second embodiment, the language localization may be performed by modifying the java application itself. The modification of the Java application will now be described with reference to the second embodiment of the invention in conjunction with FIG. 5, FIG. 6 and FIG. 7

FIG. 5 is a block diagram illustrating computing device 100, in accordance with the second embodiment of the invention. As shown in FIG. 5, program module 110 includes operating system 116, a second Java application 502, a second Java Virtual Machine (JVM) 504, a second modification module 506, and translation module 208. Second Java application 502 includes a plurality of classes. The plurality of classes are program instructions, stored in the memory 108, associated with second Java application 502. In an embodiment, second Java application 502 may include at least one text-handling class 508, a second interception class 509, and a second communication class 510. Second JVM 504 includes the plurality of JVM classes to enable execution of second Java application 502. Program data 112 includes the text strings data 214 and the language look-up file 216.

Second Java application 502 can correspond to any software application for which the program code is written in Java programming language. In an embodiment, second Java application 502 is a collection of classes included in “jar” files installed (or downloaded) during the installation (or downloading) of second Java application 502 on computing device 100. In an embodiment, second Java application 502 may include one or more classes to display content, associated with second Java application 502, on the display of computing device 100. In an embodiment, the content may correspond to one or more text strings in a first language that are to be displayed on the display of computing device 100.

A person having ordinary skill in the art would understand that one or more classes to display content in java application utilizes one or more text-displaying classes of JVM to display the text strings on the display of computing device 100.

Text-handling class 508 handles the text strings, associated with second Java application 502, to be displayed on the display of computing device 100. Text-handling class 508 is called when the text strings are to be displayed. In response, text-handling class 508 calls one or more text-displaying classes (not shown) of second JVM 504 to display the text strings on the display of computing device 100. The text strings in the first language are included in the call made by text-handling class 508. In an embodiment, the text strings include text data that is to be displayed on a user interface associated with second Java application 502.

Second interception class 509 comprises pointcuts for text-handling class 508 of second Java application 502. When the text strings are to be displayed, text-handling class 508 is called. The pointcuts for text-handling class 508 (included in second interception class 509) intercept the text strings included in the call before the text strings are transmitted to text-handling class 508. Further, the pointcuts included in the second interception class 509 transmit the intercepted text strings to second communication class 510. Second interception class 509 provides the text strings, which are translated from the first language to the second language, to text-handling class 508.

Second communication class 510 enables communication between second interception class 509 and translation module 208. Second communication class 510 receives the intercepted text strings in the first language from second interception class 509. Further, second communication class 510 transmits the text strings in the first language to translation module 208 and receives the text strings in the second language from translation module 208. Second communication class 510 then provides the text strings received in the second language to second interception class 509. In turn, second interception class 509 provides the received text strings in the second language to text-handling class 508. The interception of the text strings has been described later in conjunction with FIG. 6 and FIG. 7.

Second JVM 504 is a Java virtual machine that acts as an interface between second Java application and operating system 116. In an embodiment, second JVM 504 is similar to first JVM 204 in many respects. Further, operation of second JVM 504 is similar to first JVM 204.

Second modification module 506 is configured to modify second Java application 502 by inserting one or more classes in addition to the existing plurality of application classes of second Java application 502. In an embodiment, second modification module 506 modifies second Java application 502, by inserting second interception class 509 and second communication class 510 to the existing plurality of application classes of second Java application 502. Further, second modification module 506 is configured to insert pointcuts for text-handling class 508 of second Java application 502. The pointcuts are included in second interception class 509. Second interception class 509 intercepts (through pointcuts) the text strings to be displayed on the display of computing device 100, and redirects the text strings to second communication class 510 for translation purposes. The pointcuts control the flow of execution of second Java application 502. In an embodiment, the pointcuts include a memory location of second communication class 510. Whenever text-handling class 508 is called, the pointcuts so inserted in second interception class 509 redirect the execution to second communication class 510 by transmitting the text strings in the first language to second communication class 510. Further, second communication class 510 transmits the text strings in the first language to translation module 208. The modification of second Java application 502 has been described later in conjunction with FIG. 6.

The translation module 208 translates the language of the text strings, associated with second Java application 502, from the first language to the second language.

FIG. 6 is a flowchart 600 illustrating a method for language localization of a Java application, in accordance with the second embodiment of the invention. The flowchart 600 has been described in conjunction with FIG. 1, and FIG. 5.

The method for modifying the Java application is explained with reference to various modules and classes included in program module 110. However, those skilled in the art will readily appreciate that the various modules and classes included in the program module 110 are a set of computer program codes that are executed by processor 102 to perform tasks associated with the respective modules and classes.

At step 602, second Java application 502 (for which language localization is to be performed) is identified. In an embodiment, second modification module 506 is configured to identify second Java application 502. In an embodiment, second Java application 502 may be identified based on a user input received via the input terminal 104. A person having ordinary skill in the art would understand that computing device 100 may have more than one java applications installed. The user may provide input through the input terminal 104 to select one java application that needs to be modified.

At step 604, the plurality of application classes (i.e., classes of second Java application 302) are uncompressed. In an embodiment, second modification module 506 is configured to uncompress the plurality of application classes. In an embodiment, the plurality of application classes is program instructions stored in memory 108 to perform one or more tasks (e.g. the functionalities associated with second Java application 502). In an embodiment, the plurality of applications classes may be extracted by decompressing “jar” files corresponding to second Java application 502.

At step 606, text-handling class 508 of second Java application 502 is identified from the plurality of applications classes. In an embodiment, second modification module 506 is configured to identify text-handling class 508. In an embodiment, text-handling class 508 is used to control various text display functions associated with second Java application 502. For example, text-handling class 508 may control the display of the text strings in menus, captions, buttons and other display areas on the display (such as a display screen) of the computing device 100 with suitable font-size, color, location co-ordinates etc. as defined in second Java application 502. In an embodiment, the text-handling class 508 may transmit the text strings to second JVM 504, to display the text strings on the display of computing device 100.

At step 608, second interception class 509 and second communication class 510 are added to the plurality of application classes of second Java application 302. In an embodiment, second modification module 506 is configured to add second interception class 509 and second communication class 510. In such a scenario, second modification module 506 may introduce pointcuts for text-handling class 508 of second Java application 502. The pointcuts are introduced in second interception class 509. The pointcuts, included in second interception class 509, redirect the text strings to second communication class 510 when text-handling class 508 of second Java application 502 is called to display the text strings.

At step 610, the plurality of application classes are re-compiled. In an embodiment, second modification module 506 is configured to re-compile the plurality of application classes. In an embodiment, the re-compilation of the plurality of application classes includes re-building the “jar” files associated with second Java application 502. The plurality of application classes, during re-compilation, includes second interception class 509 and second communication class 510.

In an embodiment, the re-compiled plurality of application classes, associated with second Java application 502, may be stored in at a new memory location in memory 108. In an embodiment, the plurality of application classes may be overwritten with the re-compiled plurality of application classes. In an embodiment, path for accessing second Java application 502 may be permanently set to the memory location. In another embodiment, when the second Java application 502 is executed, the path may be set to the new folder, and when second Java application 502 exits, the path is set back to an original folder of second Java application 502.

FIG. 7 is a flowchart 700 illustrating a method for executing a Java application, in accordance with the second embodiment. The flowchart 700 is explained in conjunction with elements of FIG. 1 and FIG. 5.

At step 702, second Java application 502 is executed. In an embodiment, second java application 502 is executed by processor 102 by utilizing the plurality of JVM classes of second JVM 504. In an embodiment, second Java application 502 may be executed in response to a user input received via input terminal 104.

In an embodiment, the user may further provide input corresponding to the second language in which the user wishes to display the text strings, associated with second java application 502, on the display of computing device 100. In an embodiment, computing device 100 may include the location identification module (not shown) to determine the location of computing device 100. Based on the location, processor 102 may determine the second language.

At step 704, second Java application 502 calls text-handling class 508 when the text strings are to be displayed on the display of computing device 100. The text strings, to be displayed, are included in the call. The text strings correspond to text data, associated with the second Java application 502, which is to be displayed on a user interface associated with second Java application 502.

At step 706, the pointcuts for text-handling class 508 (which are included in second interception class 509) intercepts the text strings included in the call made by second Java application 502 before text-handling class 508 is called. The pointcuts redirect the text strings in the first language to second communication class 510.

At step 708, second communication class 510 transmits the text strings in the first language to translation module 208. Translation module 208 translates the received text strings from the first language to the second language. Translation module 208 transmits the text string in the second language to second communication class 510.

At step 710, the text strings in the second language are received by second communication class 510 from translation module 208. The text strings in the second language are provided to second interception class 509 by second communication class 510.

At step 712, text-handling class 508 is called by second interception class 509. Second interception class 509 calls text-handling class 508 with the text strings in the second language.

At step 714, text-handling class 508 calls one or more text-displaying classes (not shown) of second JVM 504. The text strings in the second language are included in the call made by text-handling class 508 to the one or more text-displaying classes of second JVM 504.

At step 716, the text strings in the second language are displayed on the display of computing device 100 by the one or more text-displaying classes of second JVM 504.

In an embodiment, language localization of Java applications in accordance with the second embodiment can be used to display images, on a user interface associated with second Java application 502, which includes text data in a desired language. In such a scenario, second Java application 502 may include original image in first language as a resource. In another embodiment, the original image may be stored in an external file and second Java application 502 may include path of external file.

Substitute images, which correspond to original images included in second Java application 502, may be added (at step 608, FIG. 6) in resources of second Java application 502. The original images include text data in the first language and the substitute images include text data in the second language. Second Java application 502 may be rebuilt (at step 610, FIG. 6) to include the substitute images.

Further, in such an embodiment, when an original image, having text data in the first language, is to be displayed, second interception class 509 may intercept a call made to an image-handling class of second Java application 502. In a scenario, where the original image is stored in an external file, the call may include filename (of the original image) and path of the original image. In another scenario, where the original image is included as the resource in second Java application 502, the call includes resource index information.

In an embodiment, a filename of the original image and a path or resource index from where the original image is to be retrieved is included in the call made to the image-handling class of second Java application 502. In an embodiment, pointcuts may be included in second interception class 509 for the image-handling class of second Java application 502 to intercept the call. Second interception class 509 redirects the file name and the path or resource index, included in the intercepted call, to second communication class 510. Second communication class 510 transmits the file name and path, or resource index of the original image (having text in the first language) to translation module 208.

Translation module 208 determines the file name and path or the resource index of a substitute image, having text data in the second language, which corresponds to the original image. In an embodiment, when the substitute image is stored in an external file (i.e. substitute image is not included in files associated with second Java application 502), the translation module 208 may determine the file name and path of the substitute image which corresponds to the original image. In another embodiment, when the substitute image is included as resources in second Java application 502, translation module may determine the resource index of the substitute image, which corresponds to the original image.

Translation module 208 transmits the file name and path or the resource index of the substitute image (having text data in the second language) to second communication class 510. Second communication class 510 transmits the file name and path or the resource index of the substitute image to second interception class 509, which in turn provides the file name and path or the resource index of the substitute image to the image-handling class of second Java application 502. The image-handling class retrieves the substitute image using the file name and path or the resource index of the substitute image, and calls second JVM 504. Second JVM 504 displays the substitute image, having text data in the second language, on the display of computing device 100.

Language localization of Java applications in accordance with the second embodiment requires no changes in the Java virtual machine. Thus, no permission or support is required from the computing device OEM. Further, in accordance with the second embodiment, language localization can be achieved for targeted Java applications. Language localization of Java applications in accordance with the second embodiment requires inserting an additional class to one or more classes of a target Java application. By inserting pointcuts for one or more classes of the Java application, the execution of the one or more classes can be redirected to the additional class. Thus, language localization can be achieved for target Java applications without changing the source code of the target Java applications.

In the present disclosure, language localization of Java applications has been described with reference to the first embodiment and the second embodiment. Those skilled in the art will readily appreciate that the first embodiment and the second embodiment may be independently implemented to achieve language localization of the Java applications.

The system, method, and computer program product, as described above, have numerous advantages. Some of these advantages may include, but are not limited to, providing support for translation to various languages without changing source code of the application software. The plurality of application classes of the software application is modified by inserting an additional class for communication. However, the source code of the original software application remains unchanged.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the Internet. The computer further comprises a microprocessor. The microprocessor is connected to a communication bus. The computer also includes a memory. The memory may be a RAM or a ROM. The computer system further comprises a storage device, which may be a hard-disk drive or a removable storage drive, such as a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as the reception of data from other sources. The communication unit may include a modem, an Ethernet card, or other similar devices, which enable the computer system to connect to databases and networks, such as LAN, MAN, WAN, and the Internet. The computer system facilitates inputs from a user through input devices accessible to the system through the I/O interface.

In order to process input data, the computer system executes a set of instructions that is stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described may also be implemented using only software programming or only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure may also be implemented in all operating systems and platforms including, but not limited to, ‘Unix’, DOS′, ‘Android’, ‘Symbian’, and ‘Linux’.

The programmable instructions may be stored and transmitted on a computer-readable medium. The disclosure can also be embodied in a computer program product comprising a computer-readable medium, or with any product capable of implementing the above methods and systems, or the numerous possible variations thereof.

Various embodiments of the method and system for language localization of the software applications have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skill in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps, and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, and the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for translating text strings associated with a Java application, the method comprising:
in a computing device:
modifying a Java virtual machine, configured to execute the Java application, to translate the text strings, to be displayed on a display of the computing device, from a first language to a second language by a translator means.

2. The method of claim 1 further comprising:
uncompressing one or more classes associated with the Java virtual machine;
identifying a text-displaying class from the one or more classes;
adding an interception class, to the one or more classes, to intercept the text strings included in a call made by the Java application to the text-displaying class for displaying the text strings;
adding a communication class, to the one or more classes, to facilitate communication between the interception class and the translator means; and
compiling the one or more classes and the communication class to build the modified Java virtual machine.

3. The method of claim 2, wherein the interception class comprises pointcuts for the text-displaying class for redirecting execution of the text-displaying class to the communication class in response to the call by redirecting the intercepted text strings to the communication class.

4. The method of claim 2, wherein the communication class transmits the text strings in the first language to the translator means and receives the text strings in the second language from the translator means.

5. The method of claim 1, wherein the translator means is at least one of: a look-up table a machine translator; a phonetic engine; and an online translation service.

6. A method for translating text strings associated with a Java application, the method comprising:
in a computing device:
transmitting, by a Java virtual machine in a computing device, text strings, to be displayed on a display of the computing device, to a translator means, wherein the translator means translates the text strings from a first language to a second language; and
displaying the text strings in the second language on the display of the computing device.

7. The method of claim 6 further comprising:
intercepting a first call from the Java application to a text-displaying class of the Java virtual machine, wherein the text-displaying class is configured to display the text strings on a display of the computing device;
transmitting the text strings in the first language to the translator means based on the intercepted first call; and
receiving the text strings in the second language from the translator means.

8. The method of claim 7, wherein the text strings, in the second language, are displayed on the display of the computing device by the text-displaying class.

9. The method of claim 7, wherein pointcuts for the text-displaying class are included in the Java virtual machine to redirect the execution of the text-displaying class to a communication class in response to the interception of the first call.

10. The method of claim 9, wherein the communication class transmits the text strings in the first language to the translator means and receives the text strings in the second language from the translator means.

11. The method of claim 6, wherein the translator means is at least one of: a look-up table a machine translator; a phonetic engine; and an online translation service.

12. The method of claim 6, further comprising:
intercepting a second call, from the Java application to an image-displaying class of the Java virtual machine, to display a first image, wherein the image-displaying class is configured to display images associated with the Java application on a display of the computing device;
transmitting a first path information of the first image, to be displayed, to the translator means, wherein the first image includes the text strings in the first language, wherein the first path information includes at least one of a filename of the first image and path from where the first image is to be retrieved;
receiving a second path information of a second image, which corresponds to the first image, wherein the second image includes the text strings in the second language wherein the second path information includes at least one of a filename of the second image and path from where the second image is to be retrieved; and
displaying the second image on the display of the computing device by the image-displaying class based on the second path information of the second image.

13. The method of claim 12, wherein pointcuts for the image-displaying class are included in the Java virtual machine to redirect the execution of the image-displaying class to a communication class in response to the interception of the second call.

14. The method of claim 13, wherein the communication class transmits the first path information of the first image to the translator means, and receives the second path information of the second image from the translator means, and wherein the translator means is a look-up table representative of a one-to-one correspondence between the first path information and the second path information.

15. A method for translating text strings associated with a Java application, the method comprising:
in a computing device having a microprocessor:
uncompressing one or more classes of the Java application;
identifying a text-handling class from the one or more classes;
adding an interception class that comprises pointcuts for the text-handling class, to the one or more classes, to intercept the text strings included in a call made to the text-handling class when the text strings are to be displayed;
adding a communication class, to the one or more classes, to facilitate communication between the interception class and the translator means, wherein the pointcuts for the text-handling class redirect execution of the text-handling class to the communication class by transmitting the text strings to the communication class, wherein the communication class further transmits the text strings to the translator means for translating the text strings from a first language to a second language.

16. The method of claim 15, wherein the translator means is at least one of: a look-up table a machine translator; a phonetic engine; and an online translation service.

17. The method of claim 15 further comprising adding a second set of images, corresponding to a first set of images associated with the Java application, wherein the first set of images include the text strings in the first language and the second set of images include the text strings in the second language.

18. The method of claim 17, wherein pointcuts for an image-handling class, to display images associated with the Java application, are included in the interception class, to transmit a first path information associated with one or more of the first set of images to the translator means, and receives a second path information associated with one or more of the corresponding second set of images from the translator means.

19. A method for translating text strings associated with a Java application, the method comprising:
in a computing device:
intercepting a first call made to text-handling class of the Java application for displaying the text strings on a display of the computing device;
redirecting the text strings to a communication class of the Java application, wherein the communication class transmits the text strings to a translator means to translate the text strings from a first language to a second language; and
displaying the text strings in the second language on the display of the computing device.

20. The method of claim 19, wherein pointcuts for the text-handling class are included in the Java application to redirect the execution of the text-handling class to the communication class in response to the interception of the first call.

21. The method of claim 19, wherein communication between the text-handling class and the translator means to transmit and receive the text strings in the first language and the second language, respectively, is established by the communication class.

22. The method of claim 19 further comprising:
intercepting a second call made to an image-handling class of the Java application when a first image, associated with the Java application, is to be displayed, wherein the first image includes the text strings in the first language;
redirecting a first path information of the first image to the communication class of the Java application, wherein the communication class transmits the first path information to the translator means to determine a second path information of a second image corresponding to the first image, wherein the second image includes the text strings in the second language; and
displaying the second image on the display of the computing device.

23. The method of claim 22, wherein pointcuts for the image-handling class are included in the Java application to redirect the execution of the image-handling class to the communication class in response to the interception of the second call.

24. A computing device for translating text strings associated with a Java application, the computing device having a microprocessor and comprising:
a modification module configured to modify a Java virtual machine, configured to execute the Java application, to include a communication class; and
the modified Java virtual machine comprising:
a text-displaying class configured to receive text strings to be displayed on a display of the computing device; and
the communication class configured to transmit the text strings to a translator means, for translating the text strings from a first language to a second language, when the text-displaying class is called by the Java application to display the text strings on the display of the computing device.

25. The computing device of claim 24, wherein pointcuts for the text-displaying class are included in the Java virtual machine, wherein the pointcuts redirect the text strings to the communication class when the text-displaying class is called by the Java application to display the text strings.

26. The computing device of claim 24, wherein the modified Java virtual machine further comprises:
an image-displaying class configured to receive first path information of a first image, associated with the Java application, wherein the first image includes the text strings in the first language; and
pointcuts for the image-displaying class, wherein the pointcuts for the image-displaying class redirects the first path information of the first image to the communication class, wherein
the communication class transmit the first path information to the translator means to determine a second path information of a second image, corresponding to the first image, wherein the second image includes the text strings in the second language.
